(19) United States
(12) Patent Application Publication
(10) Pub. No.: US 2006/0004137 A1
(43) Pub. Date: Jan. 5, 2006

(54) Coating composition

(76) Inventor: Douglas Shepherd, Woodstock, GA (US)

Correspondence Address: The Weintraub Group;Arnold S. Weintraub, Suite 240, 32000 Northwestern Highway, Farmington Hills, MI, 48334, US

(21) Appl. No.: 11/098,806

(22) Filed: Apr. 4, 2005

Related U.S. Application Data
(63) Continuation of application No. 10/850,386, filed on May 18, 2004.
Application No. 10/850,386 is a continuation-in-part of application No. 10/154,139, filed on May 23, 2002, now Pat. No. 6,737,388.

(51) Int. Cl. C08K 5/00

(52) U.S. Cl. 524/515

(57) ABSTRACT

A coating composition is an admixture of: (a) a fluorotelomer lubricant, (b) an acrylic coating (c) a solvent medium, and (d) a plasticizer. The coating hereof is particularly useful for coating paper, printed paper, conventional inks and inkjet inks, plastics, metals including copper ammunition and other products. The coating hereof is VOC-free.

### CROSS-REFERENCE TO RELATED APPLICATIONS

This application is a continuation-in-part application of co-pending U.S. patent application Ser. No. 10/850,386, filed May 18, 2004, for “Lubricant for Ammunition and other copper-surfaced articles and Method of Use Therefor”, which, in turn, is a continuation-in-part of U.S. patent application Ser. No. 10/154,139, filed May 23, 2002 for “Lubricant for Ammunition and Method of Use Therefore”, now U.S. Pat. No. 6,737,388, the disclosures of which are hereby incorporated by reference.

### BACKGROUND OF THE INVENTION

The present invention pertains to coating compositions. More particularly, the present invention pertains to coating compositions for paper, printed paper, conventional inks and inkjet inks, plastics, metals including copper ammunition and other products. Even more particularly the present invention pertains to VOC-free acrylic-based coating compositions.

### PRIOR ART

As disclosed in the above-referred to co-pending application and the now issued patent, the use of a “moly”-based lubricant for copper-surfaced articles and, in particular, for jacketed ammunition is known for enhancing the life of the bore of a firearm.

While efficacious for its intended use, the composition is limited in its universality. However, it has now been found that by eliminating the “moly” from the basic composition and substituting it with an acrylic-based composition, it is possible to provide a protective coating for paper, printed paper, conventional inks and inkjet inks, plastics, metals including, copper surfaces, ammunition, and the like.

Moreover, this basic composition can be adjusted by the addition of molybdenum disulfide and other components to accommodate a variety of surfaces, including the aforementioned ammunition.

### SUMMARY OF THE INVENTION

In accordance herewith there is provided a coating composition which, generally, comprises an admixture of: a) a polymeric lubricant, b) an acrylic coating, c) a solvent and (d) a plasticizer, which admixture provides a protective coating when applied onto or deposited onto an absorbent surface, such as paper, printed paper, conventional inks and inkjet inks, or a non-porous plastic or metal surface, such as copper, e.g. ammunition.

The coating, preferably, is applied by either: (a) spraying the coating onto the surface of the article to be coated, and, thereafter, drying the coated surface to eliminate and remove any residual solvent, (b) roll coating, (c) immersion, or the like.

By adding molybdenum disulfide to the composition it enhances the utility of the composition in surface coating copper surfaces, including copper-jacketed ammunition.

For a more complete understanding of the present invention reference is made to the following detailed description.

### DESCRIPTION OF THE PREFERRED EMBODIMENT

At the outset, and in the ensuing description, it is to be noted that the present invention is described with reference to paper having inkjet ink printed thereon. However, the present invention is of equal efficacy in connection with numerous other surfaces where coating protection is desired, as noted hereinabove.

Thus, the present invention, in a first aspect, is directed to a coating composition which comprises an admixture of: a) a polymeric lubricant, b) an acrylic coating, c) a solvent and (d) a plasticizer. This composition is deposited, preferably, by aerosol spraying, directly onto the surface of the article to be treated directly or by applying it with a moisture absorbent. However, the composition can be applied by roll coating, immersion or the like.

### The Polymeric Lubricant

The polymeric lubricant contemplated for use is a fluorotelomer such as a polytetrafluoroethylene terpolymer. Polytetrafluoroethylene terpolymers are well known and commercially available such as those sold by DuPont Chemical under the names DuPont DryFilm; RA Dispersions; DuPont DryFILM DE. These dry film compounds are described as white, waxy particles. They are sold commercially as dispersions in a solvent or as an aqueous solution thereof.

In formulating the present coating, generally, the telomer, per se, is present in an amount ranging from about 1% to about 15% by weight, based upon the entire weight of the composition.

Typical polymer dispersing solvents include, for example, fluorinated pentanes or water. Generally, the dispersion will contain about 5% to about 20% and usually about 10% to about 20%, by weight of the telomer, be it in a solvent or as an aqueous solution.

### The Acrylic Coating

The acrylic coating is used to promote the adhesion of the polymer onto the surface to be coated. The acrylic “coating” appears to create an affinity for the polymer to the surface.

Among the useful acrylic coatings is one prepared directly from a mixture of methacrylic resins sold by Röhm Chemical under the names Degalan PM 381, 64/12 and PM709 raw material, as well as the already made or pre-made coating sold by Stanchem, Inc. of East Berlin, Conn. under the mark INCRALAC. The mixture of resins, generally, comprises from about 2.0% to about 30.0%, by weight, of the Degalan 381; from 2.0% to about 30.0%, by weight, of the 64/12 and from about 2.0% to about 10.0%, by weight, of the PM709, based on the total weight of these resins.

INCRALAC is described as a 15% solids-containing thermoplastic acrylic comprising a blend of acrylic resins, a UV absorber and a chelant volatile flammable liquid having a boiling range of 180° F.-240° F. and a flash point of 40° F. to 50° F. (tag open cup).

Other useful acrylic compounds include, for example, methylmethacrylate, butyl methacrylate, isobutyl methacrylic, ethyl acrylate, copolymers thereof such as a methylmethacrylate-butylmethacrylate copolymer and the like, as well as mixtures thereof. These compounds are well-known and commercially available such as those sold by Rohm and Haas under the mark Paraloid®. Useful Paraloid® compositions include those sold under the brands: B-60, B-66, B-72, B-44 and B-67.

Generally, these Paraloid® polymers are available as a 2% to 30% solid dispersion in tert-butyl acetate or t-butyl acetate.

In the practice of the present invention it is preferred to employ a mixture of acrylic resins.

Generally, the acrylic coating is present in the admixture in an amount ranging from about 2 to about 30%, by weight, of solids material, based on the total weight of the coating composition or admixture. Where used as the pre-made material, generally, about 40% by weight of the pre-made material is employed.

### The Solvent Medium

Generally, the solvent medium will comprise from about 12.0% to about 95%, by weight, based on the total weight of the coating composition or mixture. The solvent may comprise an aromatic hydrocarbon, t-butyl acetate or mixtures thereof.

The preferred solvent is t-butyl acetate because it is a VOC-exempt solvent. As noted, the t-butyl acetate may be used alone or in admixture with the aromatic solvent or solvents. Useful aromatic solvents include, for example, benzene, toluene, xylene and the like, as well as mixtures thereof.

Where a mixture of t-butyl acetate and the aromatic hydrocarbon are used, generally, the mixture will comprise from about 10% to about 40%, by weight, of aromatic hydrocarbon and from about 60% to about 90%, by weight, of the t-butyl acetate, based on the weight of the solvent mixture.

It should be noted that among the useful aromatic hydrocarbons xylene is preferred. Also, and as noted, xylene can be used alone as long as it remains below acceptable non-VOC levels, i.e. below about 40%, in the coating composition.

Plasticizer

A plasticizer is also, used herein. The plasticizer enhances the flowability of the product. Representative of such plasticizers or a plasticizing agents are, for example, triethyl citrate, diethyl phthalate, alkyl benzyl phthalate, diacetin, triacetin, dibutyl phthalate, tributyl acetate, caster oil, fatty acids, glycerides, triglycerides and the like, an d preferably, an alkyl benzene. The amount of plasticizer to be used will vary depending on the amount of acrylic in the coating composition, Generally, though, the plasticizer will be used in an amount ranging from about 2% and 40%, by weight, based on the weight of the acrylic. Preferably the plasticizer is a C₇-C₉alkyl benzyl phthlate such as that sold commercially by Ferro Chemical under the name Santicizer® 261.

Adjuvants

Optiononally, a fluorosurfactant may be incorporated into the composition. Fluorosurfactants are well known and commercially available products and may be anionic, nonionic, cationic as well as amphoteric surfactants depending on the moiety which is fluorinated to form the surfactant. In the practice of the present invention it is preferred to employ a nonionic fluorinated surfactant. A particularly preferred nonionic surfactant is that sold by DuPont under the marks ZONYL FSG; FSN-100 and FSO-100. In use, generally, the surfactant when used is present in an amount ranging from about 0.1% to about 0.5% weight percent based on the total weight of the composition.

Other useful components that may be incorporated into the composition include, for example, a UV absorber. UV absorbers are well-known and commercially available. Among the well-known UV absorbers are, for example, benzotriazoles, including 2-(3′-tert-butyl-2′-hydroxy-5′-methylphonyl); -5-chlorobenzatriazole; 2-(2H-benzotriazol-2-yl)-4-methylphenyl and 2-(2′-hydroxy-3′,5′-di-tert-amylphenyl) benzotriazole. Hindered amine light stabilizers such as his (2,2,6,6-tetramethyl-4-piperidyl)sebacate and the like, as well as mixtures thereof. Where used, the UV absorber is present in an amount ranging from about 0.10% to about 1.0%, by weight, based on the total weight of the coating.

As indicated above, a quantity of molybdenum disulfide may, also, be used herein when coating copper surfaces, such as, ammunition, copper printing plates and the like. When used, the “moly” is present in an amount ranging from about 0.5% to about 3.0%, by weight, based on the weight of the coating composition.

The coating hereof is prepared at ambient conditions by dispersing, by mixing, the dry polymer, where used, in its solvent medium, and, then, admixing it with the acrylic and the plasticizer in the solvent medium. Otherwise, and, as noted, the composition is prepared by mixing together at ambient conditions the polymer lubricant-solvent mixture, the acrylic coating and the plasticizer, in the solvent medium. The surfactant as well as the UV absorber, where used, are, also, dispersed in the solvent medium at ambient conditions.

A particularly preferred composition herein comprises a mixture of: (a) a polymeric lubricant, (b) a mixture of acrylic resins, (c) a plasticizer, (d) at least one UV absorber, (e) at least one fluorosurfactant and (f) a solvent. The preferred composition will comprise from about 2.0% to about 30% acrylic resin(s), by weight, based on the weight of the final composition; from about 0.1% to about 1.0%, by weight, of the UV absorber, based on the weight of the acrylic resin; from about 0.001% to about 0.5%, by weight of the fluorosurfactant, based on the weight of the acrylic resin; from about 0.001% to about 10. % by weight of the polymeric lubricant, based on the weight of the acrylic resin the balance being solvent. Generally, the plasticizer is present in a 1:1 weight ratio to acrylic solids.

Optimally this liquid mixture may be packaged as an aerosol in a mixture of about 40% of coating composition to about 60% propellant or 60% of coating composition to about 40% propellant. The preferred propellant is dimethylether.

Having, thus, described the invention, what is claimed is:

1. A coating composition, comprising:
(a) fluorotelomer lubricant,
(b) an acrylic coating,
(c) a solvent medium,
(d) a plasticizer, and
wherein, the fluorotelomer is in admixture with the acrylic coating, the solvent medium and the plasticizer to form a liquid lubricant, the composition being VOC-free.

2. The composition of claim 1 wherein:
the solvent medium is present in an amount ranging from about 12% to about 95%, by weight, based on the total weight of the composition.

3. The composition of claim 2 wherein:
the solvent is selected from the group consisting of an aromatic hydrocarbon, a VOC-exempt solvent and mixtures thereof.

4. The composition of claim 3 wherein:
the VOC-exempt solvent is t-butyl acetate.

5. The composition of claim 4 wherein:
the aromatic hydrocarbon is xylene.

6. The composition of claim 3 wherein the solvent is t-butyl acetate.

7. The composition of claim 3 wherein the composition further includes a fluorinated surfactant.

8. The composition of claim 3 which further includes:
(a) a UV absorber and
(b) molybdenum disulfide

9. The composition of claim 4 wherein the acrylic coating is selected from the group consisting of methacrylate, methylmethacrylate, butyl methacrylate, isobutyl methacrylic, ethyl acrylate, methylmethacrylate-butylmethacrylate copolymer and mixtures thereof.

10. The composition of claim 2 wherein:
(a) the telomer is present in an amount ranging from about 1.0% to about 15% by weight, based on the total weight of the composition;
(b) the acrylic is present in an amount ranging from about 2% to about 30%, by weight, based on the total weight of the composition, and
(c) the plasticizer is present in an amount of about 2% to about 40%, by weight, based on the total weight of the composition.

11. The composition of claim 9 which further includes a fluorosurfactant.

12. The composition of claim 11 which further includes:
(a) a UV absorber and
(b) molybdenum disulfide

13. The composition of claim 12 wherein the fluorosurfactant is a nonionic surfactant.

14. The composition of claim 13 wherein the surfactant is present in an amount ranging from about 0.1% to about 0.5%, by weight, based on the total weight of the composition.
